(19) United States
(12) Patent Application Publication
(10) Pub. No.: US 2011/0192383 A1
(43) Pub. Date: Aug. 11, 2011

(54) INTAKE AIR/EGR MIXING SYSTEM CONFIGURATION

(75) Inventor: Jack Morais, Arlington Heights, IL (US)

(73) Assignee: International Engine Intellectual Property Company LLC, Warrenville, IL (US)

(21) Appl. No.: 12/701,966

(22) Filed: Feb. 8, 2010

(51) Int. Cl. F02M 25/07

(52) U.S. Cl. 123/568.17

(57) ABSTRACT

The intake air/EGR mixing system configuration for a V type engine wherein air entering the system via an air intake tube is split into two isolated streams by a flow divider positioned upstream of two manifold intake duct inlets, one stream leading to a respective intake duct inlet of a bank of the manifold, and wherein a mixer ring having a plurality of ports in the circumference thereof is secured within each manifold intake duct inlet, the ports feeding exhaust gas to be recirculated into the intake air stream flowing through the ring, from a split section of the exhaust gas tube leading to a respective one of said intake duct inlets, the ports in the mixer ring forming outlets for the exhaust gas feeding into the respective manifold intake duct inlet.

### BACKGROUND OF THE INVENTION

1. Field of the Invention

The present invention relates to an intake air/EGR mixing system configuration, particularly for a V configured diesel engine. More specifically, the system configuration addresses bank to bank distribution in the V configured engine by providing air to the intake manifold via two separate paths and providing two separate exhaust gas recirculation paths, one into each intake air duct of the intake manifold, the EGR being provided through a multiplicity of ports, in a direction perpendicular to the air flow via a mixer ring in each manifold intake duct, creating a more homogeneous mixture of air and recirculated exhaust gas, supplied to each bank.

2. Prior Art

A problem has always existed in attempting to provide a homogeneous mixture of air and recirculated exhaust gas (EGR) to both banks of a V configured engine.

A non-homogeneous mixture distribution potentially may not only cause emissions outside a required range but may also cause engine misfire, as well as variations in cylinder pressure across pistons of the engine, causing the engine to work improperly, producing durability issues.

Accordingly there exists a need for a more homogeneous mixing of recirculated exhaust gas and intake air being fed to such an engine.

### SUMMARY OF THE INVENTION

According to the invention there is provided an intake air/EGR mixing system configuration for a V type engine wherein air entering the system via an air intake tube is split into two isolated streams by a flow divider positioned upstream of two manifold intake duct inlets, one stream leading to a respective intake duct inlet of a bank of the manifold, and wherein a mixer ring having a plurality of ports in the circumference thereof is secured within each manifold intake duct inlet, the ports feeding exhaust gas to be recirculated into the intake air stream flowing through the ring, from a split section of the exhaust gas tube leading to a respective one of said intake duct inlets, the ports in the mixer ring forming outlets for the exhaust gas feeding into the respective manifold air inlet.

### BRIEF DESCRIPTION OF THE DRAWINGS

FIG. 1 is a perspective view of the intake air/EGR mixing system of the present invention incorporated into the environment of its use.

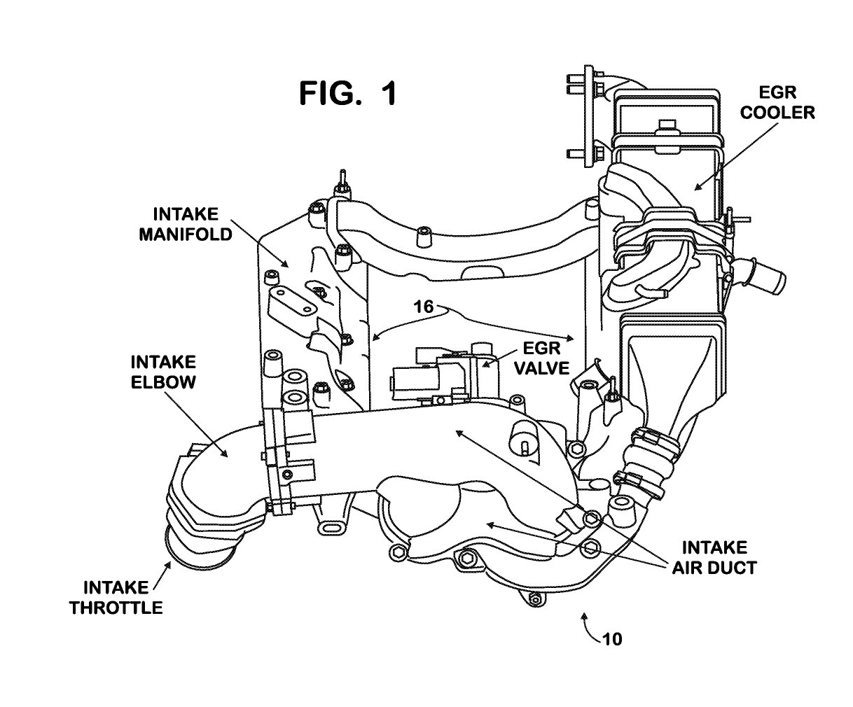

FIG. 2 is a perspective view of the intake air/EGR mixing system configuration of the present invention showing the intake air being divided into two separate and isolated (split stream) flow paths by provision of a flow divider upstream of the intake manifold intake duct inlet.

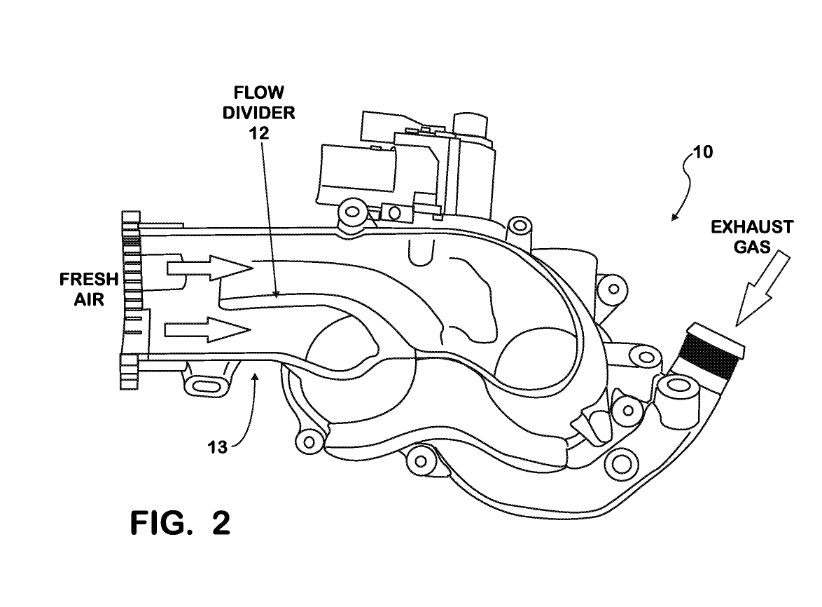

FIG. 3 is a perspective view of the intake air/EGR mixing system configuration of the present invention showing the provision of a mixer ring in each manifold intake duct inlet, each ring having a plurality of spaced apart circumferential ports therein through which EGR is fed into the inlet under pressurization to more homogenously blend into intake air flowing therepast, into the manifold intake ducts.

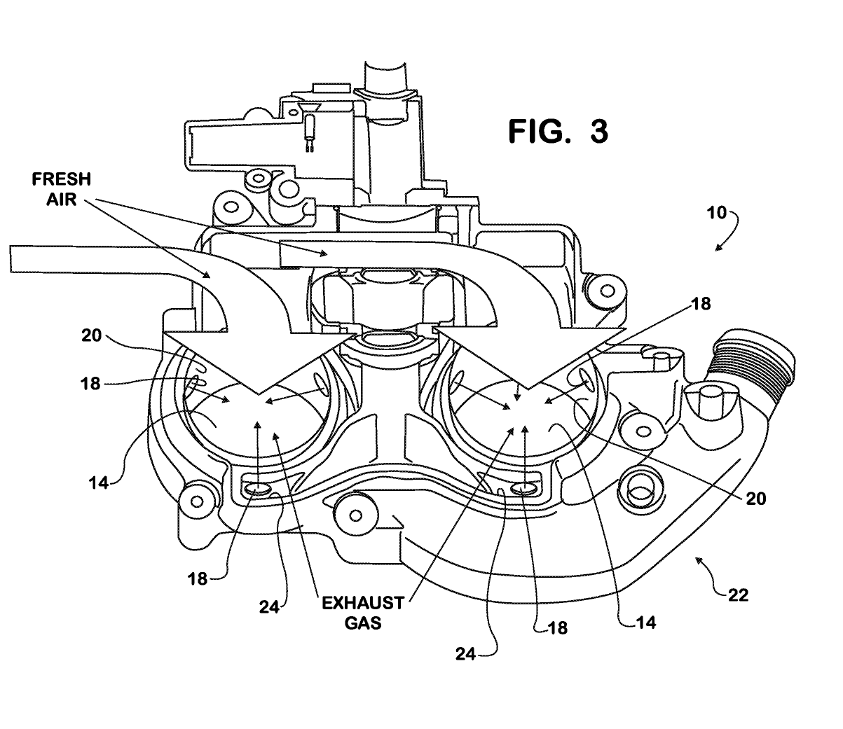

### DESCRIPTION OF THE PREFERRED EMBODIMENT

As will be understood, in prior art systems, an air/EGR mixture enters the intake inlets of a manifold, from an intake air duct into which exhaust gas to be recirculated is also entering from an exhaust gas duct, with mixing taking place upstream of the manifold intake duct inlets, with the mixture being provided to the manifold as a single stream. Such system configuration does not provide for sufficient mixing to meet upcoming standards for emissions and therefore the need arises for the improved mixing system configuration of the present invention.

The mixing system 10 configuration of the present invention addresses bank to bank intake manifold distribution of more homogeneously mixed air and recirculated exhaust gas by providing two separate paths into the intake manifold with cylinder to cylinder distribution being fine-tunable. Further, the mixing takes place in this system 10 configuration at each manifold intake inlet leading to a bank of the V engine manifold.

Delving further into the system 10 configuration, it will first be seen that a flow divider 12 is incorporated therein, within air intake duct 13, and oriented within the system 10 in a manner to produce separate and isolated (split stream) fresh air flow paths to a respective intake manifold bank duct inlet 14 of the intake manifold 16. Next, it will be seen that exhaust gas is fed into each intake manifold bank duct inlet 14 of the intake manifold 16 in a direction perpendicular to the flow of the fresh air, through a plurality of circumferentially disposed openings or ports 18 distributed around the annulus of a mixer ring 20 secured in position within each inlet 14. This configuration provides for a plurality of small high pressure streams of exhaust gas to be directed toward the center of each separate air flow path to a respective bank of manifold 16, creating an enhanced degree of mixing to produce emissions of lower levels of exhaust gas, within required limits.

The exhaust gas to be recirculated is fed to the mixing system 10 through the ports 18 of the mixer rings 20 from an exhaust tube 22 leading thereto from upstream structures common to EGR systems. However in this system 10 configuration, the exhaust tube 22 splits to provide separate EGR flow paths to each intake manifold duct inlet 14. Each split exhaust tube section 24 surrounds and terminates at the respective mixer ring 20, with the outlet ports 18 in the ring 20 producing pressurized flow radially inwardly toward the center of each manifold duct inlet 14, in a direction perpendicular to the flow of fresh air therethrough.

The now divided pressurized exhaust gas flow into a respective one of two separate and isolated air flow paths, each leading to a respective manifold intake duct inlet 14, will produce significantly improved mixing, effectively lowering exhaust emissions to acceptable standards.

As described above, the system 10 configuration of the present invention provides a number of advantages, some of which have been described above and others of which are inherent in the invention. Also, modifications can be proposed to the system 10 configuration without departing from the teachings herein. Accordingly the scope of the invention is only to be limited as necessitated by the accompanying claims.

1. An intake air/EGR mixing system configuration for a V type engine wherein air entering the system via an air intake tube is split into two isolated streams by a flow divider positioned upstream of two manifold intake duct inlets, one stream leading to a respective intake duct inlet of a bank of the manifold, and wherein a mixer ring having a plurality of ports in the circumference thereof is secured within each manifold intake duct inlet, the ports feeding exhaust gas to be recirculated into the intake air stream flowing through the ring, from a split section of the exhaust gas tube leading to a respective one of said intake duct inlets, the ports in the mixer ring forming outlets for the exhaust gas feeding into the respective manifold air inlet.

2. The system configuration of claim 1 wherein the flow divider is upstream of the mixer rings.

3. The system configuration of claim 1 wherein the exhaust gas entering the manifold duct inlet is directed into the intake air stream in a direction perpendicular to the flow thereof.

4. The system configuration of claim 1 wherein the exhaust gas is pressurized as it flows through the ports.

5. The system configuration of claim 4 wherein the exhaust gas is forced radially inwardly toward the center of the intake air stream by the pressurization.

6. The system configuration of claim 1 wherein each manifold intake duct inlet is provided with a separate and isolated air stream and a separate and isolated exhaust gas stream.
